(19) United States
(12) Patent Application Publication
(10) Pub. No.: US 2015/0142135 A1
(43) Pub. Date: May 21, 2015

(54) DOOR/WINDOW SENSOR

(71) Applicant: Fibar Group sp. z o.o., Poznan (PL)

(72) Inventors: Maciej Fiedler, Poznan (PL); Bartlomiej Arcichowski, Poznan (PL); Adam Przybecki, Poznan (PL)

(21) Appl. No.: 14/543,849

(22) Filed: Nov. 17, 2014

Related U.S. Application Data
(60) Provisional application No. 61/904,671, filed on Nov. 15, 2013.

(51) Int. Cl. G05B 15/02; H04L 12/28

(52) U.S. Cl. CPC G05B 15/02; H04L 12/2803
USPC 700/11

(57) ABSTRACT

A control system for use with a control device in a network. The control system includes a sensing device to monitor a distance of the sensing device from the control device, and to communicate a first indication in response to the distance exceeding a predefined value through the network. The control system also includes a binary device coupled to the sensing device, and, in response to receiving a number of inputs, to generate a number of signals, and to communicate the number of signals through the network via the sensing device. The control system also includes a network manager that is remote from the binary device and the sensing device, to receive at least one of the first indication and the number of signals, and, in response to having received the at least one of the first indication and the number of signals, to activate one of a plurality of corresponding predefined actions.

### CLAIM OF PRIORITY/INCORPORATION BY REFERENCE

This patent application makes reference to, claims priority to and claims benefit from U.S. Provisional Patent Application Ser. No. 61/904,671 entitled “Door/Window Sensor” filed on Nov. 15, 2013, which is hereby incorporated herein by reference in its entirety.

### TECHNICAL FIELD

Aspects of the present disclosure relate to electronic systems and/or networking. More specifically, certain implementations of the present disclosure relate to a door/window sensor.

### BACKGROUND

Existing methods and systems for providing device monitoring or control can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for a door/window sensor, substantially as shown in and/or described in connection with at least one of the figures, as set forth more completely in the disclosure and/or the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example home network.

FIG. 2 illustrates an example door/window sensor.

FIGS. 3A-B illustrate example operation of a door/window sensor with example sensor devices.

FIG. 4 illustrates an example flow chart of a method for an example process of operation of one or more door/window sensors.

FIG. 5 illustrates an example a door/window control system.

### DETAILED DESCRIPTION

Certain implementations may be found in a method and system for a door/window sensor. In one embodiment, the present invention provides a control system for use with a control device in a network. The control system includes a sensing device to monitor a distance of the sensing device from the control device, and to communicate a first indication in response to the distance exceeding a predefined value through the network. The control system also includes a binary device coupled to the sensing device, and, in response to receiving a number of inputs, to generate a number of signals, and to communicate the number of signals through the network via the sensing device. The control system also includes a network manager that is remote from the binary device and the sensing device, to receive at least one of the first indication and the number of signals, and, in response to having received the at least one of the first indication and the number of signals, to activate one of a plurality of corresponding predefined actions.

In another embodiment, the present invention provides a control system for use with a control device in a network. The control system includes a network device communicatively coupled to said network to perform a function, a sensing device to monitor a distance of the sensing device from the control device, and to communicate a first indication in response to the distance exceeding a predefined value, and a network manager that is remote from the network device, and being communicatively coupled to the network device and to the sensing device, to receive the first indication, and in response to having received the first indication, to communicate a second indication to the sensing device. The sensing device, in response to having received the second indication from the network manager, communicates the second indication to the network device through the network. The network device, in response to having received the second indication from the sensing device through the network, performs the function.

In still another embodiment, the present invention provides a method of controlling a network device operable to perform a function in a network via a) a sensing system for use with a control device, and being remote from said network device, and b) a network manager operable to communicate with the network device and the sensing system. The method includes determining a distance of the sensing device from the control device, and in response to having detected the distance exceeding a predefined value, communicating a first indication from the sensing system to the network manager. The method also includes in response to having received the first indication at the network manager, communicating a second indication from the network manager to the sensing device, in response to having received the second indication at the sensing device, communicating the second indication from the sensing device to the network device, and performing the function at the network device in response to receiving the second indication at the network device.

As utilized herein the terms “circuits” and “circuitry” refer to physical electronic components (i.e. hardware) and any software and/or firmware (“code”) which may configure the hardware, be executed by the hardware, and/or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and/or “module” refer to functions than may be performed by one or more circuits. As utilized herein, the term “example” means serving as a non-limiting example, instance, or illustration. As utilized herein, the terms “for example” and “e.g.” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

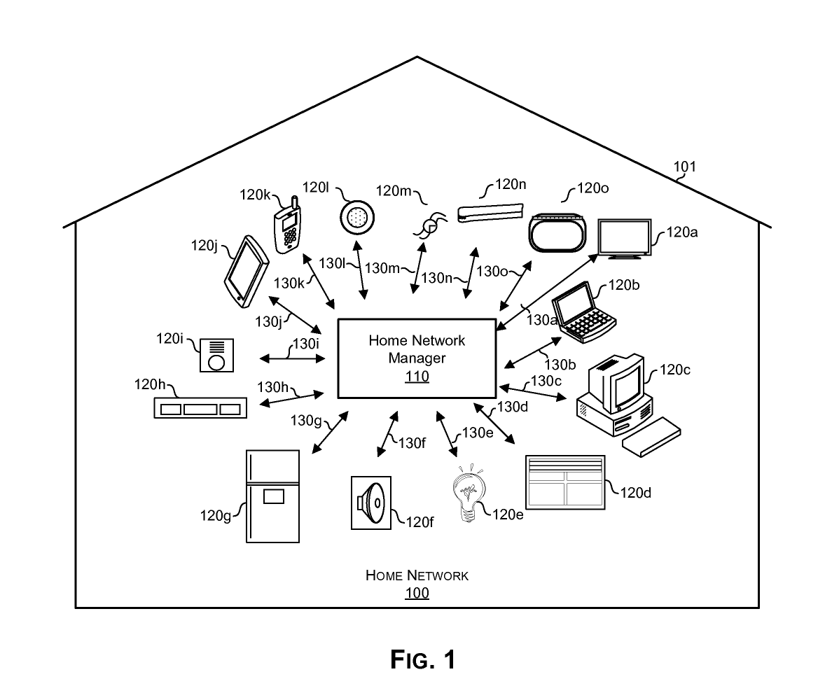

FIG. 1 illustrates an example home network. Referring to FIG. 1, there is shown a home network 100.

The home network 100 may correspond to a location 101. The location 101 may, for example, correspond to a residence (e.g., home, apartment) or non-residence premises (e.g., small business, school, library, factory, or the like). In this regard, the home network 100 may, for example, comprise a plurality of home network elements, such as, for example, a plurality of home network elements 120a-120o. The home network elements (e.g., home network elements 120a-120o) may, for example, comprise one or more devices, systems, fixtures, appliances, and/or other circuitry. The home network elements (e.g., home network elements 120a-120o) may comprise, for example, one or more televisions 120a, one or more computers (e.g., laptop computer 120b, desktop computer 120c), one or more personal and/or handheld devices (e.g., tablet 120j, mobile phone 120k, smart watch 120m), one or more multimedia devices and/or components (e.g., speakers 120f), one or more structural fixtures (e.g., windows/window blinds 120d, smart watch), one or more lighting and/or electrical fixtures 120e, one or more appliances (e.g., refrigerator 120g), one or more environmental sensory devices 120h (e.g., thermometers, humidity meters), and/or one or more security devices 120i (e.g., a smoke detector, a carbon monoxide detector, a security alarm, a motion detector), one or more sensors and/or controllers (e.g., intelligent motion sensor 1201, roller shutter controller 120n, door/window sensor 120o).

The disclosure is not limited to any particular type of a home network. Furthermore, the disclosure is not limited to any particular combination of home network elements. It is to be understood that although the network is referred to as a “home network” throughout the disclosure, the disclosure is not limited in this way. Specifically, the network may comprise any other network that may be operable to control one or more network elements. For example, the network of the disclosure (whether or not referred to as a “home network”) may be implemented in a residential, non-residential, commercial, industrial and/or any other setting. Similarly, the network elements may comprise network elements (whether or not referred to as a “home network elements”) implemented in a residential, non-residential, commercial, industrial and/or any other setting.

In some instances, the home network 100 may incorporate a home network manager 110. The home network manager 110 may comprise suitable circuitry, interfaces, logic, and/or code for implementing various aspects of the present disclosure. For example, the home network manager 110 may be configured for use in managing, servicing, and/or interacting with one or more home network elements. Although the home network manager 110 is shown in FIG. 1 as a single and separate device, the disclosure is not limited in this way. For example, in some implementations, one or more functions of the home network manager 110 may be provided by one or more home network elements (e.g., providing user interface via tablet 120j and/or television 120a). In an example embodiment of the disclosure, the home network manager 110 may be implemented as a virtual platform, such as, for example, one or more software modules may run on, and/or utilize resources of one or more home network elements (e.g., laptop 120b, desktop 120c).

The home network manager 110 may be configured to communicate with one or more elements (e.g., home network devices, home network elements) in a home network. In an example embodiment of the disclosure, the home network manager 110 may be operable to communicate with one or more devices and/or systems that may be external to a home network, using, for example, optical, wired and/or wireless communication links.

Although the home network manager 110 is illustrated as a single device, the disclosure is not limited in this way. For example, the home network manager may comprise one or more home network manager that may each interact with one or more home network elements (e.g., home network elements 120a-120o). In an example embodiment of the disclosure, each of the one or more home network managers may be associated with particular one or more home network elements. In another example, one or more of the one or more home network managers may be associated with any one or more home network elements (e.g., home network elements within range of a particular home network manager, with best communication path).

In an example embodiment of the disclosure, the home network manager 110 may be implemented in an integrated or a distributed system. An integrated system may be implemented, for example, on one computer, server, machine or device, where the integrated system may be configured to perform some or all of the functions, features and/or operations of the home network manager 110 as described herein. A distributed system may be implemented with multiple components (e.g., computers, servers, machines and/or devices), where each of the multiple components may be configured to perform some or all of the functions, features and/or operations of the home network manager 110 as described herein. Each function, feature and/or operation may be implemented on one or more of the components of the distributed system. For example, a specific feature, function and/or operation may be implemented only one component of the distributed system or it may be implemented across multiple components of the distributed system.

In an example embodiment of the disclosure, in addition to or instead of the use of one or more home network managers, the home network 100 may comprise one or more master controllers for controlling one or more home network elements. A master controller may be pre-programmed and/or programmable to control one or more home network elements. A master controller may comprise, for example, a remote controller.

Although the disclosure may refer to a single home network manager, it is to be understood that the disclosure is not limited in this way. For example, the home network manager may comprise one or more home network managers that individually and/or in the aggregate may be implemented as integrated and/or a distributed system.

The home network manager 110 may interact with one or more of the home network elements 120a-120o via corresponding links 130a-130o, which may be supported by the home network manager 110 and/or the corresponding home network element(s). For example, the links 130a-130o may be implemented and/or configured to operate using a wireless protocol, such as, for example, a Z-wave protocol. In an example embodiment of the disclosure, the home network 100 may be implemented as Z-Wave network. However, the disclosure is not limited in this way. For example, the home network 110 may comprise one or more wired and/or wireless links and/or protocol. Wireless links and/or protocols, may comprise, for example, WPAN (e.g., Bluetooth or ZigBee), low power links (e.g., Bluetooth LE (BLE), Bluetooth Smart, iBeacon), near field communication protocols (e.g., NFC) and/or WLAN (WiFi/802.11) protocols and/or any other wireless links and/or protocols suitable for implementation consistent with the disclosure. Wired protocols and/or links may comprise, for example, Ethernet, Universal Serial Bus (USB), and/or any other wired links and/or protocols suitable for implementation consistent with the disclosure.

In an example embodiment of the disclosure, home network manager 110 may interact with one or more home network elements (e.g., home network elements) directly and/or indirectly. For example, the home network manager 110 may interact with one or more home network elements directly through a corresponding link (e.g., wireless, wired link/connection).

In another example, the home network manager 110 may interact with one or more home network elements indirectly though, for example, a converter (e.g., global cache.) In this regard, the home network manager 110 that supports one or more particular network interfaces and/or other interfaces (e.g., USB) may be operable to interact with a particular network element (and/or another device) that may otherwise be incompatible with one or more of the one or more particular network and/or other interfaces supported by the home network manger 110. The interaction may be achieved though, for example, a converter and/or a translator. The converter and/or the translator may each comprise suitable logic, circuitry, interfaces, and/or code that may be operable to facilitate communication between a home network manager (e.g., the home network manger 110) and a home network element (home network elements 120a-120o).

In another example, the home network manager 110 may interact with one or more home network elements indirectly though, for example, other network elements. In this regard, the home network manager 110 may interact with one or more home network elements on, for example, a mesh network. An example mesh network (not shown) may facilitate communication (e.g., transmission of messages, signals, data frames) to and/or from the home network manager (e.g., the home network manager 110) to and/or from a particular network element where the communication may, for example, pass through one or more other network elements before reaching the particular network element and/or the home network manager.

In an example embodiment of the disclosure, the home network manager 110 may be operable to support one or more communication methods from one or more other home network devices (e.g., home network elements 120a-120o). For example, one or more home network elements may communicate with the home network manager 110 utilizing a particular wireless link and/or protocol (e.g., Z-wave) and/or a particular wired link and/or protocol (e.g., Ethernet), while one or more other home network elements may communicate with the home network manager 110 utilizing a different particular wireless link and/or protocol (e.g., WiFi) and/or a different particular wired link and/or protocol (e.g., USB).

In an example embodiment of the disclosure, the same one or more home network elements may communicate with the home network manager 110 by, for example, using one or more wired and/or wireless links and/or protocols at the same and/or at different times. For example, a particular network element may communicate with the home network manager 110 using a Z-Wave communication protocol for a particular communication and may communicate with the home network manager 110 using a WiFi communication protocol for another particular communication.

In an example embodiment of the disclosure, one or more home network elements (e.g., home network elements 120a-120o) may communicate with one or more home network elements (e.g., home network elements 120a-120o) directly. In this regard, the one or more network elements may utilize one or more communication links (e.g., wireless, wired) (not shown) and/or one or more network interfaces and/or other interfaces without directing (e.g., routing the communication thought, for example, a home network manager (e.g., the home network manger 110). For example, a home network element may be operable to detect existence of one or more other network elements (e.g., on the same and/or different network) and may initiate, send and/or receive communication to and/or from the one or more other network elements.

In an example embodiment of the disclosure, one network element may be out of range of a home network manager and may communicate with one or more other network elements to determine whether the one or more other network elements are within range of a particular (e.g., a home network manager previously within range of the one network element) and/or any network manager. The range detection and/or discovery may continue from one network element to another. For example, a particular home network element may need to communicate through more than one other home network element in order to, for example, communicate with a desired home network element and/or a desired, particular and/or any home network manager (e.g., the home network manager 110). The disclosure is not limited to a communication for a purpose of range discovery/detection. The communication may comprise any type of communication and may be used for a variety of other purposes (e.g., communicating with a different network element, communicating with a home network manager, controlling an out of range device, controlling another network element).

In an example embodiment of the disclosure, one or more home network elements (e.g., home networks elements 120a-120o) may be operable to control one or more other home network elements (e.g., home networks elements 120a-120o) with and/or without intermediary, such as, for example, a home network manager (e.g., home network manager). For example, one or more home network elements may be operable to control one or more other home network elements through an intermediary. In this regard, a particular network element may communicate with an intermediary (e.g., home network manager) in order to communicate with and/or to control another home networks element. An intermediary may comprise one or more devices (e.g., a preprogrammed and/or programmable master controller, home network manager) that may be operable to control one or more network elements. In another example, a particular network element may directly communicate with and/or to control another home network element.

In an example embodiment of the disclosure, one or more home network elements (e.g. home network elements 120a-120o) and/or other devices that may be operable to communicate on the network (and/or an associated network as described herewith) and/or that may not be operable to communicate on the network but may otherwise be tractable (e.g., GPS, iBeacon, electronic tag), with one or more other network elements, devices and/or a network manager (e.g., home network manager 110) associated with a particular network (e.g., home network 100) (and/or an associated network as described herewith), may communicate with each other, other devices (e.g., on the same network, another network and/or otherwise connected and/or tractable) and/or the network manager, and/or may be operable to determine a precise location of a particular network element, device and/or network manager utilizing various communication protocols and/or interfaces.

For example, one or more network elements (and/or other devices operable on the network, an associated network as described herewith and/or otherwise traceable) may be operable to generate and/or receive information and/or one more signals and/or messages that may be utilized in determining a location of a particular network element, device and/or network manager. In this regard, a near field communication and/or a low power interface protocol (e.g., BLE, iBeacon) may be utilized for communication between the elements, devices and/or network managers. Furthermore, one more tags (e.g., small electronic devices) may be utilized, to facilitate location of particular elements, devices and/or network managers. For example, a network element, device and/or home network manager may generate a signal and/or a message (on the network, on an associated network and/or through a built in, external, portable and/or otherwise attachable tag) that may be received by another network element, device and/or network manager.

In an example embodiment of the disclosure, one or more home network elements, devices and/or manager may cooperate (e.g., exchange information) to, for example, collectively and/or individually determine a precise location of a particular network elements, device and/or network manager based on the received one or more signals and/or messages. As an example only, a particular network element, device and/or home network manager may generate a signal and/or a message that may be received by other network element, device and/or home network device within a particular time frame. The information about the time it took to, for example, receive the particular one or more signals and/or messages (and/or the information gather from the one or more signals and/or messages, such as, for example, signal strength) may be used to determine the precise location (e.g., distance to/from the network element, device, network manager that received the particular one or more signals and/or message) of the particular network element, device and/or network manager

In operation, the home network manager 110 may be operable to manage a home network (e.g., the home network 100). The home network manager 110 may be utilized, for example, as an interface platform for interacting with various network elements (e.g., the home network elements 120a-120o). In this regard, the home network manager 110 may support establishing and/or configuring one or more communication connections/links (e.g., the links 130a-130o) with the one or more elements of the home network 110. Once established, the connectivity between the home network manager 110 and the home network elements (e.g., elements 120a-120o) may, for example, be utilized to enable centralized monitoring, control, and/or management of the home network elements, and/or of the home network 100 as a whole. For example, the home network manager 110 may be operable to control operations of certain elements (e.g., turn on television 120a, switch to particular channel(s) at particular days/times, and/or record if recording is supported); monitor environment in the home network, such as by obtaining environmental readings (e.g., temperature, humidity, etc.) via example environmental sensory devices 120h, and may process these readings (e.g., to determine if/when to adjust other home network elements accordingly); adjust one or more example lighting and/or electrical fixtures 120e (e.g., turn lights on or off); lower/raise example window (blinds) 120d; adjust operations of example appliances (e.g., refrigerator 120g), such as, for example, based on a preconfigured power efficiency/optimization profile; monitor for any indications of a security/safety problem, based on, for example, input from example security devices 120i, and/or act accordingly (e.g., send notifications to users, such as by texting example smartphone 120k, and/or automatically notify authorities, e.g., by dialing ‘911’ and/or contacting preconfigured emergency numbers).

In an example embodiment of the disclosure, the home network manager 110 may provide and/or utilize user interface services in the home network. In this regard, the home network manager 110 may be operable to support use of user interface functions, and/or to generate and/or store information corresponding thereto, which may be utilized to enable interactions between the home network manager 110 and users (e.g., in the home network 100). For example, in some implementations, the home network manager 110 may be configured to generate and/or use a graphic user interface (GUI), for visually displaying information and/or providing interactivity with users (e.g., for providing input thereby). One or more user interfaces may enable configuring the home network manager 110 and/or functions provided by the home network manager 110. In an example embodiment of the disclosure, the one or more user interfaces may enable user interaction with, configuring and/or adjusting other elements in the home network 100 (e.g., elements connected to the home network manager 110).

In an example embodiment of the disclosure, the user interfaces may be provided via one or more other devices that may be communicatively coupled to the home network manager 110. For example, a GUI generated and/or used by the home network manager 110 may be displayed using existing home network elements, such as, for example, television 120a, laptop 120b, tablet 120j, and/or smartphone 120k.

The disclosure is not limited to a single network (e.g., home network 100) and/or a single network manager (e.g., home network manager 110). For example, one or more networks (e.g., home network 100) and/or one or more network managers (e.g., home network manager 110) may be grouped together. The grouping may correspond to one or more locations (e.g., location 101).

In an example embodiment of the disclosure, a network (e.g., home network 100) may be associated with one or more network managers (e.g., home network manager 110). For example, one network manager may be associated with one or more networks (e.g., home network 100) and/or locations (e.g., location 101),

In an example embodiment of the disclosure, a grouping of networks may comprise one or more network, network managers and/or locations. The grouping may be programmable and/or configurable. For example, one more networks may be defined, one or more network managers may be assigned per network and/or associated with one or more devices with a network and/or a network manager. In this regard, the information may be shared between the different networks, network managers and/or devices assigned to the different networks and/or network managers. For example, information gathered on one network (e.g., by a network device, through an occurrence of a condition, event, an alarm, and/or other predefined and/or preconfigured condition) may cause the information to be communicated on the same and/or another associated network. In this regard, the information may trigger a condition, an alarm, an occurrence of an event and/or any other predefined and/or preconfigured condition (e.g., operation of a device, network element) on the same and/or another associated network.

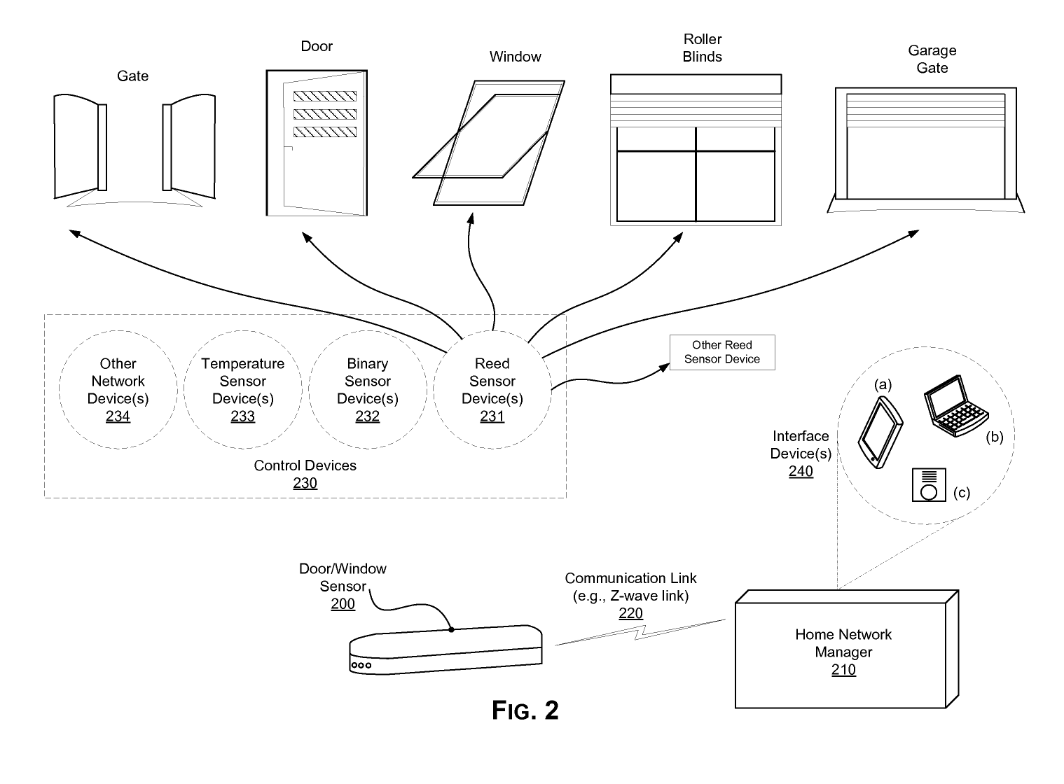

In an example embodiment of the disclosure, one or more home network elements (e.g., home network elements 120a-120o) may be configured to provide enhanced functionality, especially in the context of the home network provided by home network managers (e.g., the home network manager 110). For example, rather than utilizing a typical door/window sensor, an enhanced door/window sensor may be utilized, such as to provide enhanced door/window monitoring functions, device interface functions and/or other functions in a home network (e.g., the home network 100). An example door/window sensor is depicted in and/or described with respect to FIG. 2.

FIG. 2 illustrates an example door/window sensor. Referring to FIG. 2, there is shown a door/window sensor 200.

The door/window sensor 200 may comprise suitable circuitry, interfaces, logic, and/or code for implementing various aspects of the present disclosure. The door/window sensor 200 may be implemented and/or configured to provide enhanced monitoring and connectivity of one or more sensor or network devices, such as, for example, one or more control device(s) 230, other device monitoring, connectivity, control and/or related functions.

A control device 230 may comprise one or more reed sensor devices (e.g., reed sensor device(s) 231), one or more binary sensor devices (e.g., binary sensor devices(s) 232), one or more temperature sensor devices (e.g., temperature sensor device(s) 233) and/or one or more other network devices (e.g., home network elements 120a-k, network device(s) 234).

A reed sensor device 231 may comprise a device that may be monitored via a reed sensor and/or any other sensor operable to monitor a status (e.g., open, closed, partially open/closed) of the reed sensor devices consistent with the disclosure. For example, a reed sensor device 231 may comprise one or more doors, windows, window and/or door blinds (e.g., roller blinds) and/or other window and/or door treatment solutions, awnings, garage doors, gates and/or any other devices that may be monitored by and/or connected to a door/window sensor, such as, for example, the door/window sensor 200.

Although the disclosure refers to a reed sensor device, the disclosure is not limited in this way. A reed sensor device may comprise any device that may be monitored for an open, closed, partially opened and/or partially closed state (or any other state) irrespective of whether a reed sensor/method, a magnetic sensor/method and/or any other sensor/method may be utilized for detection of the open, closed, partially open and/or partially closed state (or any other state).

A binary sensor device 232 may comprise a device that may be monitored by, for example, detection of a binary output from the binary sensor device 232 (e.g., presence or absence of DC voltage). For example, a binary sensor device 232 may comprise a fire alarm, a smoke sensor, a motion sensor, a switch (e.g., on/off switch), and/or any other device that may be operable to generate a binary output to a door/window sensor 200.

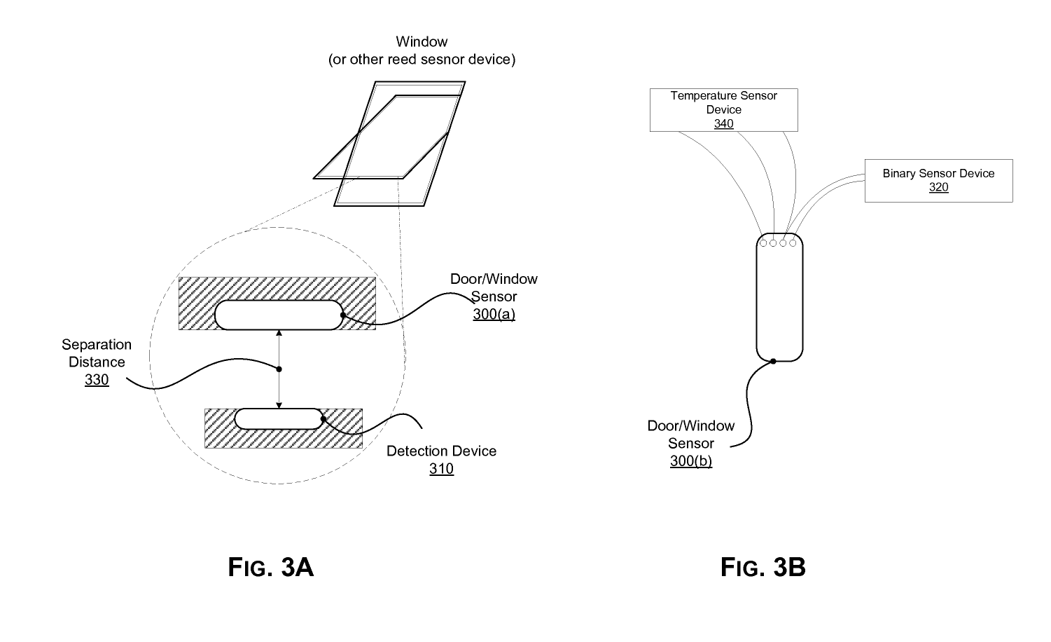

A temperature sensor device 233 may comprise one or more sensors operable to sense ambient temperature (e.g., outdoors, and indoors). Example operation of an example door/window sensor with respect to monitoring a temperature sensor device is depicted and/or described with respect to FIG. 3B.

A network device 234 may be similar to a home network element, such as, for example home network element(s) 120a-k, other devices (e.g., intelligent wall plug, roller shutter controller, door/window sensor, flood sensor) and/or a network manager (e.g., home network manger 210).

The door/window sensor 200 may be operable to monitor of one or more reed sensor devices (e.g., reed sensor device(s) 231). In an example embodiment of the disclosure, the door/window sensor 200 may be operable to monitor whether a reed sensor device is open, closed and/or partially opened and/or closed. Example operation of an example door/window sensor with respect to monitoring a reed sensor device is depicted and/or described with respect to FIG. 3A.

In operation, the door/window sensor 200 may operate and/or control other devices (directly and/or indirectly) based on the state of a reed sensor device (e.g., open, closed). The door/window sensor 200 may control the devices directly through, for example, sending a communication message on the network (e.g., home network 100) that may be received by a particular device to be controlled by the door/window sensor 200. The door/windows sensor 200 may control the devices indirectly through, for example, communicating with a network manager (e.g., home network manager 210) that may in turn communicate with a particular device to be controlled.

In an example embodiment of the disclosure, the door/window sensor 200 may detect that a front gate was opened and may, for example, turn on particular (e.g., based on preconfigured and/or preprogrammed settings) lighting fixtures automatically. In another embodiment, the door/window sensor 200 may initiate running of a scene based on the change of a state of a particular reed sensor device. For example, the door/window sensor 200 may run, for example, a “Return Home” scene when it detect that a front gate or garage door was opened (or based on any other predefined and/or preconfigured condition).

The conditions for running a scene may also include, for example, time of the day, day of the week, lighting conditions, conditions based on location services, such as, for example, based on presence of a particular mobile device within the vicinity of a predefined and/or preconfigured location. A scene may comprise a variety of sequential and/or simultaneous events that may operate and/or adjust settings of any network element, including elements directly connected to the network (e.g., home network 100) through a home network manager, elements connected through other network elements and/or devices (e.g., shutter devices connected through a roller shutter controller), and/or otherwise connected to the network and/or operable to be controlled through the network and/or one or more elements and/or devices on the network.

In an example embodiment of the disclosure, the door/window sensor 200 may be operable to prevent and/or allow operation of other devices. For example, based on a state of a particular reed sensor device (e.g., reed sensor device(s) 232), the door window/sensor 200 may prevent and/or allow for operation of other devices. As one example, the doors/windows sensor 200 may prevent from turning on a heating or cooling unit in a room when a window is open (e.g., based on a status of a reed sensor device, such as, for example, the window).

Similarly, when for example, the door/window sensor 200 detects that the particular window was closed, it may allow for operation of a heating or cooling unit to bring the temperature in the room to a desired (e.g., preprogrammed and/or preconfigured) temperature. The temperature reading may be obtained via a temperature sensor device (e.g., temperature sensor device(s) 233). In another example embodiment, the door/window sensor 200 may simply allow for the operation of the heating or cooling unit that may independently (or through other devices) obtain the temperature reading in a particular location.

The door/window sensor 200 may be operable to detect and/or process the binary output of the binary sensor device 232. In this regard, the door/window sensor 200 may be responsive to the output from the binary sensor device 232. For example, the door/window sensor 200 may receive output from the binary sensor device 232 and may generate a message on a home network (e.g., home network 100) in response to such an output. Example operation of an example door/window sensor with respect to monitoring a binary sensor device is depicted and/or described with respect to FIG. 3B.

In operation, the door/window sensor 200 may be operable as a network extension. For example, the door/window sensor 200 may be connected to a binary input device (e.g., binary input device 232), such as, for example, a wall switch, that may be operational to control virtually any device without the need to run additional wires and/or within a need to provide particular support for the device on the network (e.g., home network 100).

In an example embodiment of the disclosure, the door/window sensor 200 may be connected to a wall switch (or any other switch) that may or may not be otherwise connected to any other device. In this regard, the door/window sensor 200 may act as a wireless entry point. For example, toggling the switch may be configured (through, for example, a network manager) to perform any sequence of events (simultaneously, in sequence, separated by a predefined period of time) on the network. For example, toggling the switch connected to a door/window sensor 200 may activate operation of any other device on the network. For example, toggling the switch may close window blinds (through communication with, for example, a roller shutter controller), turn on lights (through communication with a relay or dimmer switch), etc.

In an example embodiment of the disclosure, toggling a switch that may be, for example, associated with a garage door (or otherwise activating the switch to, for example, close the door via a wireless controller) may trigger a predefined action or scene that may be initiated by a door/window sensor 200. For example, on closing the garage gate, the door/window sensor 200 may activate “Away from Home” scene and may initiate closing all or some roller blinds, turning on or off particular lighting fixtures, etc.

In another example embodiment of the disclosure, the door/window sensor 200 may operate in connection with an RFID reads (e.g., car module) to activate a scene.

In an example embodiment of the disclosure, a scene may be triggered via an input other than from a switch. For example, a scene may be activated by a change in state of a binary sensor device, such as, for example, a motion sensor. For example, when motion is detected on the back porch as scene associated with such an even may be activated.

In another example embodiment of the disclosure, the door/window sensor 200 may be operable to activate one or more scenes based a sequential input. For example, a door/window sensor 200 may be connected to a switch. In this regard, the door/window sensor 200 may activate a particular scene based on, for example, a number of sequential clicks. For example, click once for a “Movie Scene” (e.g., dimming lights, adjusting background settings, home theater settings), click twice for a “Dinner Scene” (e.g., turn on light over a dinner table, turn off TVs), etc.

The disclosure is not limited to any type of devices that the door/window sensor 200 may control. Furthermore, the disclosure is not limited to any particular scene or sequence of events that may be activated and/or initiated by operation and/or functionality of the door/window sensor 200. It is to be understood that the type of devices to be controlled, the setting on the devices and/or any scenes may be preprogrammed, preconfigured and/or otherwise customized based on the desired outcome.

In an example embodiment of the disclosure, a door/window sensor (e.g., door/window sensor 200) may communicate with one or more other door/window sensors in order to monitor one or more control devices (e.g., control device(s) 230) that may be controlled by the one or more other door/window sensors. In another example, a door/window sensor (e.g., door/window sensor 200) may communicate with one or more network devices (e.g., 120a-k).

The communication may be direct and/or indirect. For example, the communication may be directly between the one door/window sensor and one or more other door/window sensors (and/or other network devices). In an example embodiment of the disclosure, an intermediary may be involved in an initial configuration of the communication between the one door/window sensor and one or more other door/window sensors (and/or other network devices). In another example, the communication may be indirect through, for example, an intermediary (e.g., network element, door/window sensor, home network manager, master controller).

In an example embodiment of the disclosure, operation of a door/window sensor (e.g., door window sensor 200) may trigger operation of another network device (e.g., network device 120a-k) or a network manager (e.g., home network manager 210). For example, when a door/window sensor detects a state change of a monitored control device (e.g., control device(s) 230), operation of one or more other network devices (e.g., network device 120a-k) and/or one or more network managers (e.g., home network manager 210) may be triggered, such that, for example, the one or more network devices and/or one or more network managers may operate one or more devices that may be associated with the one or more network devices and/or the one or more network managers (e.g., when the gate is opened, the lights on the front and/or back porch turn on, a message is generated by a network manager, such as, for example, a text message comprising an alert that a front gate is now open).

The door/window sensor 200 may comprise one or more buttons (and/or other interfaces) (not shown) either inside or outside of the door/window sensor 200 for providing basic functionality to the door/window sensor 200. For example, the door/window sensor 200 may comprise one or more buttons that may be pressed and/or depressed sequentially and/or for a predetermined and/or preconfigured amount of time to operate one or more functions of the door/window sensor 200. One or more functions of the door/window sensor 200 may comprise range testing (e.g., whether the door/window sensor is within a home network), connecting to a home network (e.g., paring between a door/window sensor and a home network through, for example, a network manager) and/or temper prevention.

In an example embodiment of the disclosure the one or more buttons may be located inside of the door/window sensor 200, such that, for example, when the door/window sensor 200 is tampered with (e.g., casing is opened) the button may, for example, become depressed. In this regard, the door window sensor 200 may generate a temper alarm condition. The condition may be communicated on the home network (e.g., home network 100), to other devices and/or a home network manager (e.g., home network manager 210).

The door/window sensor 200 may comprise one or more visual and/or audible indicators (e.g., LED(s), speaker(s), and/or other interfaces) (not shown) either inside or outside of the door/window sensor. The one or more visual and/or audible indicators may be used in connection with, for example, providing visual and/or audible cues indicative of, for example, the status of the door/window sensor 200 (e.g., within home network range, connected to a home network, in paring mode) and/or operation the one or more buttons.

In an example embodiment of the disclosure, the operation of the door/window sensor 200 may be initiated by pre-defined and/or preconfigured condition that the door/window sensor 200 may be operable to determine and/or receive an indication thereof. For example, the door/window sensor 200 may be operable to determine and/or receive an indication of a condition that may, for example, be determinable through, for example, a sensor. In this regard, the door/window sensor 200 may comprise one or more sensor and/or may receive input from one or more sensors and/or sensory devices. For example, the door/window sensor 200 may generate a status and/or an alarm message in response to an input from a sensor. In this regard, the door/window sensor may receive an indication of, for example, an inside and/or outside temperature from a temperature sensor. The door/window sensor 200 may generate a status and/or an alarm message (e.g., temperature exceeds a predefined limit and may be indicative of overheating, fire, air conditioning malfunction, etc.) in response to the sensory reading (e.g., temperature, rain conditions, time of day).

In an example embodiment of the disclosure, the door/window sensor 200 may comprise a temperature sensor. The temperature sensor may be operatively connected to the door windows sensor 200 as, for example, an external device (e.g., temperature sensor device(s) 233) and/or may be integrated with the door/windows sensor 200. The door/window sensor 200 may be operational to generate one or more stats messages and/or alarm messages based on the input from the temperature sensors.

In one example, a door/window sensor 200 may monitor a reed sensor device (e.g., reed sensor device 231) and may determine that the state of the device is closed (e.g., the window is closed). Yet, for example, the temperature sensor may indicate that the inside temperature is very low which may be indicative that the reed sensor device is not fully closed (e.g., there is a draft and it may be cold outside).

In another example, the door/window sensor 200 may utilize the input from the temperature sensor to, for example, determine the ambient temperature with respect to a temperature schedule. For example, the door/window sensor 200 may report the ambient temperature (e.g., as detected by a temperature sensor) from a particular location (e.g., room) to, for example, a network manager (e.g., a home network manger 210) and/or a thermostat control unit, for the network manager and/or the thermostat unit to adjust operation of, for example, a heating and/or cooling device such that the temperature in the particular location may be adjusted to a desired temperature based on a temperature schedule for the particular location (e.g., based on the time of day, location).

In yet another example, the door/window sensor 200 may utilize the input from the temperature sensor to, for example, determine whether an alarm and/or a fire condition have occurred. For example, the temperature exceeds a predefined limit, the door/window sensor 200 may generate an alarm message to the network (e.g., home network 100), to another network device and/or a network manager (e.g., home network manager 210) indicative of a possible fire condition.

In another example, the door/window sensor 200 may utilize the input from the temperature sensor to, for example, determine any other predefined and/or preconfigured conditions. For example, when the temperature drops below and/or rises above a predefined and/or preconfigured limit, the door/window sensor 200 may generate other status and/or alert messages.

The door/window sensor 200 may be configured for operation on a home network (e.g., home network 100 as depicted in and/or described with respect to FIG. 1), such that, the door/window sensor 200 may be utilized as a home network element. In this regard, the door/window sensor 200 may be configured to interact, for example, in a home network (e.g., home network 100 as depicted in and/or described with respect to FIG. 1) with, for example, a home network manager (e.g., home network manager 210). The home network manager may be substantially similar to the home network manager 110 as depicted in and/or described with respect to FIG. 1.

The door/window sensor 200 may be configured to interact with the home network manager 210 via, for example a communication link 220. The communication link 220 may, for example, comprise a Z-Wave link. The disclosure is not limited to any particular type of a communication link. For example, the door/window sensor 200 may be implemented to support, for example one or more wireless and/or wired links, protocols and/or connections. For example, wireless links, protocols and/or connections, may comprise, for example, WPAN (e.g., Bluetooth or ZigBee) and/or WLAN (WiFi/802.11) protocols and/or any other wireless links, protocols and/or connections suitable for implementation consistent with the disclosure. Wired links, protocols and/or connections may comprise, for example, Ethernet, Universal Serial Bus (USB), and/or any other wired links, protocols and/or connections suitable for implementation consistent with the disclosure. While not shown in FIG. 2, to support communication with other elements or systems, such as the home network manager 210, the door/window sensor 200 may incorporate a communication transceiver (e.g., a Z-Wave transceiver) and/or related processing resources for allowing use of the door/window sensor 200.

In an example embodiment of the disclosure, the door/window sensor 200 may provide wired and/or wireless interfaces that may enable one or more network devices to connect to a home network (e.g., home network 100) and/or home network manager (e.g., home network manager 210). For example, if the network manager provides connectivity of various devices to a home network, for example, based on a Z-Wave protocol, the door/window sensor 200 may, for example, contain suitable circuitry, interfaces, logic, and/or code that may enable a particular device that, for example, may not be compatible with the example Z-Wave protocol (and/or any other particular protocol that the network manager supports) to connect to the network manager and/or the home network. For example, the door/window sensor 200 may allow for monitoring of binary sensor devices (e.g., binary sensor device(s) 232) that may otherwise be incompatible of being monitored on a particular home network and/or by a particular network manager.

In an example embodiment of the disclosure, the door/window sensor 200 may comprise one or more input/output (“I/O”) interfaces. The I/O interface may comprise suitable logic, circuitry, interfaces, and/or code that may be operable to enable user interactions with the door/window sensor 200 through interfaces, such as, for example, interfaces provided by the example interface device(s) 240a-c. The I/O interface may obtain input from user(s) of the door/window sensor 200 and/or provide output to the user(s). The I/O interface may support various types of inputs and/or outputs, including, for example, video, audio, and/or textual. In this regard, dedicated I/O devices and/or components, external to or integrated within the door/window sensor 200, may be utilized for inputting and/or outputting data during operations of the I/O interface. Exemplary (external or integrated) I/O devices may comprise displays, mice, keyboards, touchscreens, voice input interfaces, and other input/output interfaces or devices.

The example interface device(s) 240a-c may, for example, provide a graphical user interface (GUI) for controlling the operation of one or more door/window sensors (e.g., door/window sensor 200) and/or monitoring one or more control devices (e.g., control device(s) 230) associated with the one or more of the one or more door/window sensors.

In an example embodiment of the disclosure, the door/window sensor 200 may be operable to communicate with a network manager (e.g., home network manager 210). The door/window sensor 200 may communicate, to the network manager, information and/or data relating to, for example, status of the door/window sensor 200, one or more reed sensor devices (e.g., reed sensor device(s) 231), binary sensor devices (e.g., binary sensor devices 232), temperature sensor devices (e.g., temperature sensor device(s) 233) and/or other network devices (e.g., network device(s) 234) that may be monitored by and/or connected to the door/window sensor 200. The communications may comprise status information, predefined and/or predetermined (e.g., alarm) conditions and/or any other information that may be relevant to the operation of the door/window sensor 200, the one or more reed sensor devices and/or binary sensor devices that may be monitored by and/or connected to the door/window sensor 200, the and/or any other information that may be relevant to the operation of a home network. The status and/or predefined and/or predetermined (e.g., alarm) conditions may comprise status and/or alarm conditions associated with operation of reed sensor and binary sensor devices (e.g., open/closed, on/off, alarm condition on/off, not responding), door/window sensor status (e.g., door/window sensor on/off) and/or any other information.

In an example embodiment of the disclosure, the door/window sensor 200 may also receive communications from the network manager. The communications may, for example, comprise information relating to predefined and/or predetermined conditions and/or information comprising commands that may be executed on the door/window sensor 200 (e.g., activate binary sensor device, for example, in response, to an alarm condition).

In an example embodiment of the disclosure, the door/window sensor 200 may incorporate a wireless range tester (not shown) that may be operable to, for example, determine whether the door/window sensor 200 is within a range of a home network manager (e.g., home network manager 210) and/or other network element. In this regard, the door/window sensor 200 may be operable to generate an alarm condition when the door/window sensor 200 is not within a range of any home network manager (e.g., home network manager 210) and/or other network element and/or when the door/window sensor 200 that, for example, was previously within the range of a (e.g., home network manager 210) and/or other network element, is now outside of that range. In an example embodiment of the disclosure, the alarm condition may active one or more alarm indicators to generate an alarm condition by, for example, generating an audible and/or a visual alarm.

In another example embodiment of the disclosure, the home network manager 210 may be operable to generate an alarm condition, when for example, the door/window sensor that, for example, was previously within the range of the home network manager 210, is now outside of that range.

In another example embodiment of the disclosure, wireless range tester may indicate whether the door/window sensor 200 is in range, is in an intermediate range and/or is out of range of a home network manager. The in range indication may, for example, be associated with a condition where the door/window sensor 200 may establish a direct connection with a home network manager (e.g., home network manager 210) and whether or not a direct communication is desirable (e.g., the door/window sensor 200 may, for example, communicate with the home network manager utilizing other network elements although a direct communication would be possible). The in an intermediate range condition may, for example, be associated with a condition where the door/window sensor 200 may not establish a direct connection with a home network manager (e.g., the home network manager 210) but may establish an indirect communication with the home network manager (e.g., through other network elements). The out of range indication may, for example be associated with a condition where the door/window sensor 200 may not be able to establish either a direct and/or in direct communication with a home network manager (e.g., the home network manager 210).

In an example embodiment of the disclosure, the door/window sensor 200 may indicate whether the door/window sensor is in range (e.g., direct, indirect) and/or out of range through one or more audio and/or visual indicators. The indicators may be, for example, integrated with and/or external to the door/window sensor 200. For example, the door/window sensor may comprise an external visual indicator (e.g., LED, RGB, RGBW light) that may be operable to display the status of the door/window sensor 200 with respect to the range through different colors and/or illumination schemes. For example, a visual indicator may display a different color depending on the in-range status (e.g., one color may indicate that the door/window sensor 200 is in a direct range, a second color may indicate that the door/window sensor 200 is in indirect range and/or a third color may indicate that the door/window sensor 200 is out of range). In another example, the visual indicator may blink at different frequencies, illuminate without blinking and/or be operable to display different illumination schemes depending on the in-range status of the door/window sensor.

In an example embodiment of the disclosure, the door/window sensor 200 may comprise other suitable circuitry, interfaces, logic, and/or code for implementing various aspects of the present disclosure. For example, the door/window sensor 200 may comprise a memory and/or a processor.

The memory may store, for example, configuration data, which may comprise parameters and/or code, comprising software and/or firmware. The memory may comprise different memory technologies, including, for example, read-only memory (ROM), electrically erasable programmable ROM (EEPROM), random access memory (RAM), low latency nonvolatile memory, flash memory, solid-state drive (SSD), field-programmable gate array (FPGA), and/or other suitable electronic data storage capable of storing data, code and/or other information.

In an example embodiment of the disclosure, the door/window sensor 200 may be operable to receive software and/or firmware updates. For example, the door/window sensor 200 may receive software and/or firmware updates from a network manager (e.g., the home network manager 210). In an example embodiment of the disclosure the software and/or hardware updates may be received, processed and/or installed automatically and/or manually. For example, the process may be completely automatic (e.g., a network manager may send an update to the door/window sensor and the door/window sensor may process it automatically), and/or semi-automatic (e.g., an update may be initiated by a user through, for example, a network manager, and may, for example, be processed by the door/window sensor automatically) and/or manual (e.g., an update may be initiated by a user through, for example, a network manager and/or through an interface on the door/window sensor, and may, for example, be processed by the door/window sensor in response to a user action indicative of a desire to install the particular update (e.g., through an interface).

The processor may comprise suitable circuitry, interfaces, logic, and/or code that may be operable to process data, and/or control and/or manage components, operations and/or functions of the door/window sensor 200, and/or tasks performed therein. In this regard, the processor may configure and/or control operations of various components and/or subsystems of the door/window sensor 200, such as, for example, the memory, the communication subsystem (e.g., for communicating with, for example, the home network manager 210) by utilizing, one or more control signals.

FIGS. 3A-B illustrate example operation of a door/window sensor with example sensor devices.

Referring to FIGS. 3A-B, there is shown a door/window sensor 300(a) and 300(b), respectively. Each of the door/window sensor 300(a) and/or 300(b) may be substantially similar to the door/window sensor 200 as depicted in and/or described with respect to FIG. 2.

Referring to FIG. 3A there is also shown a detection device 310. The detection device 310 may comprise suitable logic, circuitry, interfaces, and/or code that may be operable to support operation of a door/window sensor (e.g., door/window sensor 300(a)). The detection device 310 may comprise, for example, a magnet (e.g., electromagnet, permanent magnet). The detection device 310 may generate an electromagnetic field that may be detected by a door window sensor (e.g., door window sensor 300(a)). The electromagnetic field may, for example, cause one or more reeds within the circuitry of a door/window sensor to close and close an electrical circuit. The electrical circuit may be closed when, for example, a separation distance (e.g., separation distance 330) between the detection device 310 and a door/window sensor (e.g., door/window sensor 300(a)) is within a predefined and/or preconfigured limit.

In example operation, when the separation distance 330 exceeds a predefined and/or preconfigured distance such that, for example, the electromagnetic field generated by a detection device (e.g., detection device 310) may no longer cause one or more reeds in an example circuitry of a door/window sensor to come in contact (e.g., the current does not flow and/or the circuit is not closed), the door/window sensor may, for example, detect that a particular device is in an open state.

In another example operation, when the separation distance 330 is below a predefined and/or preconfigured distance such that, for example, the electromagnetic field generated by a detection device (e.g., detection device 310) may cause one or more reeds in an example circuitry of a door/window sensor to come in contact (e.g., the current does not flow and/or the circuit is not closed), the door/window sensor may, for example, detect that a particular device is in a closed state.

The disclosure is not limited to any particular detection device. For example, the detection device may comprise any other device that may facilitate the door/window sensor (e.g., door window sensor 200, 300(a)) to detect whether a device (e.g., door, window, roller blinds) are in a particular state (e.g., open, closed). Furthermore, the disclosure is not limited to utilizing a detection device. For example, the detection device may be optional and the door/window sensor (e.g., door window sensor 200, 300(a))) may be operational without a detection device. In this regard, the door/window sensor may be operational to detect a particular state of a device (e.g., open, closed) without any input and/or without any interaction with another device, such as, for example, a detection device (e.g., detection device 310).

Referring to FIG. 3B there is also shown a binary sensor device 320 and a temperature sensor device 340. The binary sensor device 320 may be sustainably similar to one or more of the one or more binary sensor device(s) 232 as depicted and/or described with respect to FIG. 2. The temperature sensor device 340 may be sustainably similar to one or more of the one or more temperature sensor device(s) 233 as depicted and/or described with respect to FIG. 2.

In an example embodiment of the disclosure, a door/window sensor (e.g., door/window sensor 300(b)) may integrate with a binary sensor device (e.g., binary sensor device 320). In this regard, the door/window sensor may be responsive to the output from the binary sensor device 320 (e.g., motion sensor, flood sensor, alarm system). For example, the door/window sensor may receive output from the binary sensor device and may generate a message on a home network (e.g., home network 100) in response to such an output.

In an example embodiment of the disclosure, a door/window sensor (e.g., door/window sensor 300(b)) may integrate with a temperature sensor device (e.g., temperature sensor device 340). In this regard, the door/window sensor may be responsive to the output from the temperature sensor device 340. For example, the door/window sensor may receive output from the temperature sensor device and may generate a message on a home network (e.g., home network 100) in response to such an output.

In an example embodiment of the disclosure, door/window sensor (e.g., door/window sensor 300(b)) may provide one or more wired and/or wireless interfaces that may enable one or more binary or temperature sensor devices (e.g., binary sensor device 320, temperature sensor device 340) to connect to a home network (e.g., home network 100) and/or home network manager (e.g., home network manager 210). For example, if the network manager provides connectivity of various devices to a home network, for example, based on a Z-Wave protocol, the door/window sensor may, for example, contain suitable circuitry, interfaces, logic, and/or code that may enable a particular binary or temperature sensor device that, for example, may not be compatible with the example Z-Wave protocol (and/or any other particular protocol that the network manager supports) to connect to the network manager and/or the home network.

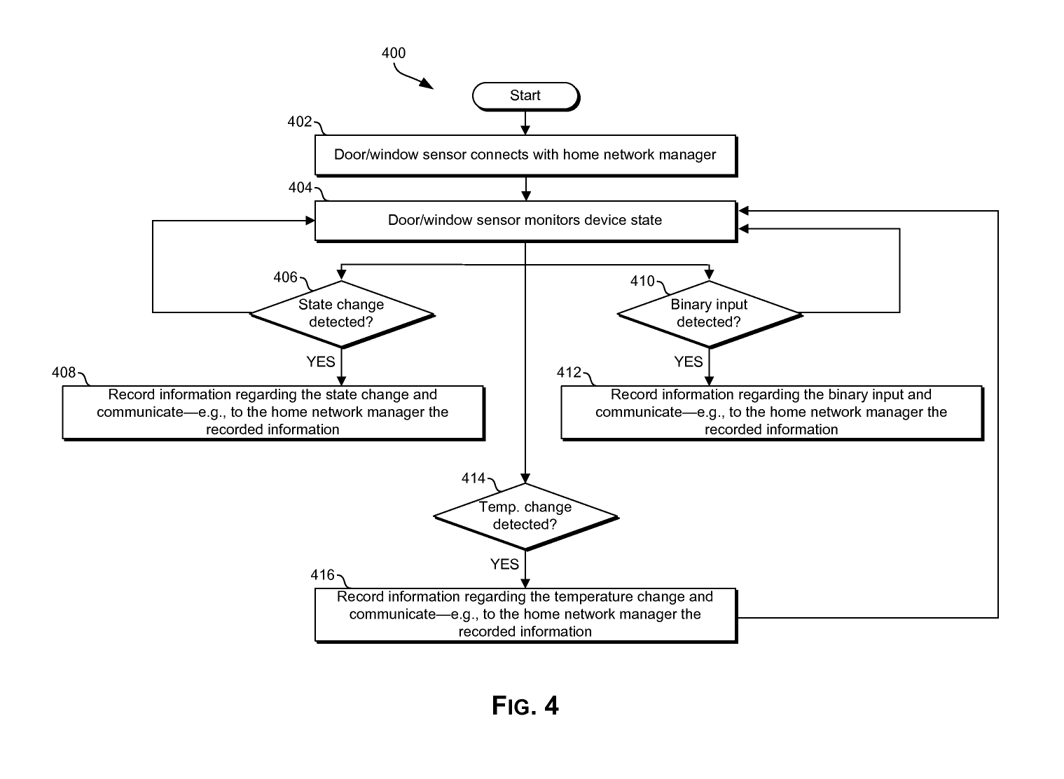

FIG. 4 illustrates an example flow chart of a method for an example process of operation of one or more door/window sensors. Referring to FIG. 4, there is shown a flow chart 400 comprising a plurality of example steps.

In example step 402, a door/window sensor (e.g., the door/window sensor 200 as depicted in and/or described with respect to FIG. 2) may connect with a home network manager (e.g., the home network manager 210 as depicted in and/or described with respect to FIG. 2). The connection may comprise a communication link (e.g., the communication link 220 as depicted in and/or described with respect to FIG. 2), such as, for example, a Z-Wave link. The connection may comprise one or more types of wireless and/or wired connections. The connecting may, in some instances, comprise determining whether the door/window sensor is within range of the home network manager. In this regard, the door/window sensor may incorporate a wireless range tester for determining whether the door/window sensor is within a range of a home network manager as described with respect to FIG. 2, for example.

In example step 404, a door/window sensor may monitor device state. The monitoring may be ongoing, periodic, may be initiated by another device (e.g., network device, home network manager) and/or may be initiated by a change a condition (e.g., temperature).

In example step 406, a determination may be made whether a state of a monitored device has changed. For example, a determination may be made whether a reed sensor device has been, for example, opened or closed. In instances where no state change has been detected, the process may loop back to the example step 404. In instances where a state change has been detected, however, the process may proceed to example step 408.

In example step 408, information regarding the state change may be recorded. The recorded information may then be reported. In this regard, the information may be communicated to other systems (e.g., the home network manager, through communication links between the home network manager and the door/window sensor). In an example embodiment of the disclosure, the recordation step may be optional and/or the information may be communicated outside of the door/window sensor (e.g., to network manager).

In example step 410, a determination may be made whether a binary input of a binary sensor device has changed. For example, a determination may be made whether a binary sensor device has been, for example, activated (e.g., alarm condition is on/off). In instances where no binary input change has been detected, the process may loop back to the example step 404. In instances where a binary input change has been detected, however, the process may proceed to example step 412.

In example step 412, information regarding the binary input may be recorded. The recorded information may then be reported. In this regard, the information may be communicated to other systems (e.g., the home network manager, through communication links between the home network manager and the door/window sensor). In an example embodiment of the disclosure, the recordation step may be optional and/or the information may be communicated outside of the door/window sensor (e.g., to network manager).

In example step 414, a determination may be made whether a temperature change has been detected changed. For example, a determination may be made whether the temperature has exceeded (e.g., is under or above a predetermined and/or preconfigured threshold). In instances where no temperature change has been detected, the process may loop back to the example step 404. In instances where a temperature change has been detected, however, the process may proceed to example step 416.

In example step 416, information regarding the temperature change may be recorded. The recorded information may then be reported. In this regard, the information may be communicated to other systems (e.g., the home network manager, through communication links between the home network manager and the door/window sensor). In an example embodiment of the disclosure, the recordation step may be optional and/or the information may be communicated outside of the door/window sensor (e.g., to network manager).

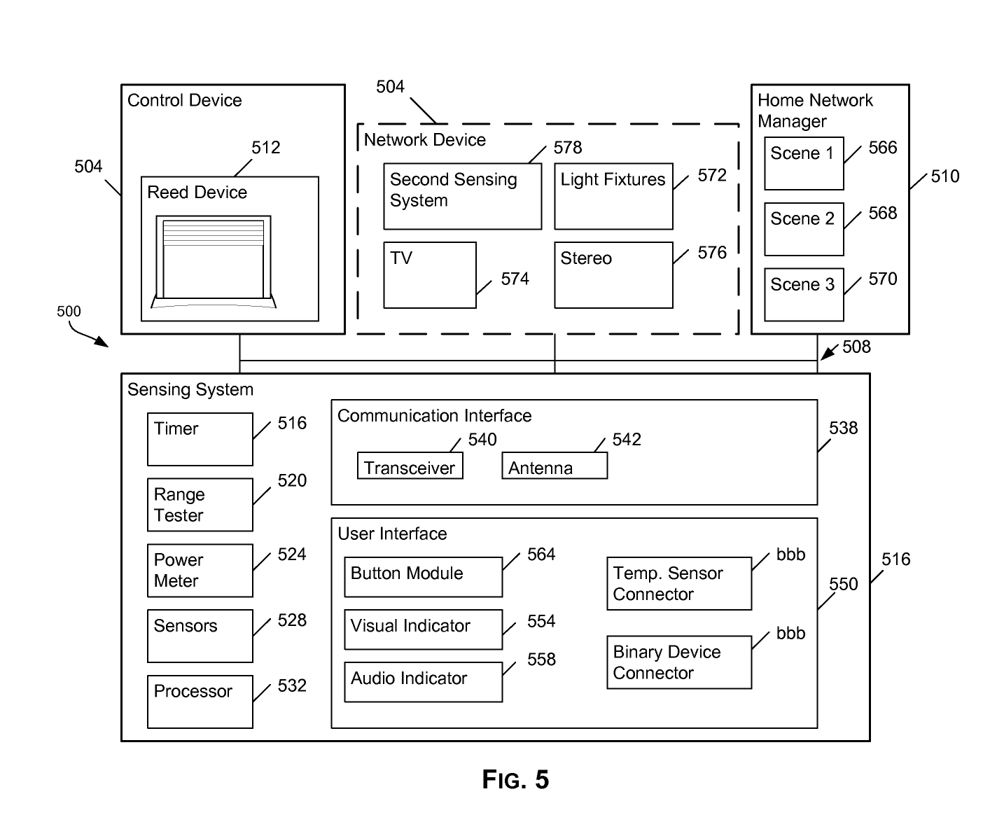

FIG. 5 illustrates an example door/window control system or control system 500 for use with a control device 504, similar to the control devices 230 of FIG. 2, in a home network 508, similar to the home network 100 of FIG. 1, to communicate with a home network manager 510, similar to the home network manager 110 of FIG. 1 and the home network manager 210 of FIG. 2. In the embodiment shown, the control device 504 includes one or more reed sensor devices 512, similar to the reed sensor device 231 of FIG. 2. In some embodiments, the reed sensor devices 512 may include a device in the form of a gate, a door, a window, a set of roller blinds, and a garage gate, that may be monitored.

In the embodiment shown, the control system 500 also includes a sensing device 516, similar to the door/window sensor 200 of FIG. 2. The sensing device 516 may include a plurality of modules and/or devices including a timer 518, a range tester 520, a power meter 524, sensors 528, and a processor 532. For example, the sensors 528 may monitor or determine a distance between the sensing device 516 and the control device 516. For example, if the sensing device 516 or the processor 532 determines that the distance exceeds a predefined value, such as, for example, 30 mm, for example, when a door is opened, the processor 532 may generate a first indication.

As discussed above, the sensing device 516 may use the range tester 522 to determine if the sensing device 516 is within a range of the home network manager 510. If the sensing device 516 or the range tester 520 determines that the sensing device 516 is within a range of the home network manager 510, the home network manager 510 may be associated with the sensing device 516. In some embodiments, the sensing device 516 may be associated with the home network manager 510 through a different sensing device 516, or other network devices, similar to 120a-120o of FIG. 1.

In some embodiments, the power meter 524 may record data indicative of the power consumption associated with the sensing device 516 or the control device 504. In this regard, the recorded information may be communicated to other network devices, similar to 120a-120o of FIG. 1, and/or the home network manager 510, through communication links between the home network manager 510 and/or the sensing device 516.

In the embodiment shown, the sensors 528 may include one or more sensors, such as, for example, a temperature sensor, to determine or monitor temperature, weather and/or timing conditions proximate the sensing device 516 and/or the control device 504, depending on applications. For example, the sensing device 516 may operate the shutter device 534 in response to changing weather and/or timing conditions as detected by the sensors 528. In this regard, the shutter controller 512 may receive an indication of, for example, an outside temperature through the sensors 528.

The processor 532 may also include internal memory for storing data with respect to operations of the sensing device 516 and power metering information as discussed above. In some embodiments, the sensors 528 may sense a condition, such as, for example, an exterior temperature, or, as discussed above, a distance between the sensing device 516 and the control device 504. The processor 532 may determine if the sensed condition, the sensed temperature, the sensed distance, meets or exceeds a predefined condition, such as, for example, a temperature threshold, or a predefined value, the processor 532 may generate an actuation signal.

In this regard, the sensing system may also include a communication interface 538 to transmit through a transceiver 540 and/or an antenna 542 data indicative of the actuation signal to the control device 504, the home network manager 510, and/or the network device 536. In the embodiment shown, the control device 504 includes the reed sensor 512 and a garage gate 544. In some embodiments, in response to receiving data indicative of the actuation signal, the home network manager 510 may cause the garage gate 512 to move to an open position in which the garage gate 512 may be completely opened, a closed position in which the garage gate 512 may be completely closed, and a third position in which the garage gate 512 is between the open position and the closed position. In the embodiments where the control device is in the form of a set of roller blinds, the actuation signal may also include data or signals to tilt some or all of the blades to a predefined number of degrees. In some other embodiments, a user may configure the number of tilting degrees through the network device 536 (for example, the home network manager 510), or a user interface 550.

In the embodiment shown, the user interface 550 may also include a visual indicator 554, an optional audio indicator 558 to generate audial signals, such as, for example, an alarm signal. For example, in some embodiments, when the sensing device 516 is determining an operating range with the range tester 520 with respect to the home network manager 510, the audio indicator 558 may generate a first audial signal to indicate an appropriate operating range, and may generate a different audial signal to indicate an inappropriate operating range, for example, when the sensing device 516 is outside of the operating range of the home network manager 508. For another example, in some embodiments, when the sensing device 516 is determining an operating range with the range tester 520 with respect to the home network manager 510, the visual indicator 558 may generate a visual indication, such as, for example, slowly blinking and/or of one color, to indicate an appropriate operating range, and may generate a different visual indication, such as, for example, rapidly blinking and/or of another color, to indicate an inappropriate operating range, for example, when the sensing device 516 is outside of the operating range of the home network manager 508.

In the embodiment shown, the user interface 550 may also include a temperature sensor connector 560, a binary device connector 562, and a button module 564. The temperature sensor connector 560 allows a user to connect a temperature sensor (not shown) to the sensing device 516. In some embodiments, the temperature sensor may monitor temperature proximate the sensing device 516. As discussed above, if the temperature monitored proximate the sensing device 516 exceeds a predefined temperature limit, such as, for example, 80° F., for an amount of time as determined by the home network manager 510 or by the processor 532, the home network manager 510 or the processor 532 may generate an indication. The communication interface 538 or the home network manager 510 may communicate the indication to a network device, such as, for example, a ventilation system (not shown), for a preconfigured action, such as, for example, activating the ventilation system to higher capacity.

The binary device connector 562 enables a user to connect a binary device, similar to the binary device 232 of FIG. 2, to the sensing device 516. In such embodiment, the sensing device 516 may also perform as a communication module, a transmitter, or a repeater for the binary device. For example, the binary device may be an existing wall switch. Having connected the existing wall switch to the sensing device 516 through the binary device connector 562, a user may control one or more of the network device 504 with the existing wall switch. In this regard, as discussed above, the home network manager 510 may include a plurality of predefined actions or scenes to correspond to input received at the binary device. For example, the binary device may receive three different types of sequential inputs, such as, for example, one click, two clicks, and three clicks. Correspondingly, the home network manager 510 may include three preprogrammed or predefined scenes 566, 568, and 570. In some embodiments, the scene 566 may correspond to the one-click input received at the binary device, the scene 568 may correspond to the two-click input received at the binary device, and the scene 570 may correspond to the three-click input received at the binary device. For example, the scene 566, the one-click input, may activate a light fixture 572 of the network device 504. The scene 568, the two-click input, may activate a TV 574 of the network device 504. Similarly, the scene 570, the three-click input, may activate a stereo system 576 of the network device 504.

The button module 564 may enable a user to test an operating range of the sensing device 516, as discussed above. In this regard, the button module 564 may communicate with the range tester 520 to perform a range testing, as discussed above. The range tester 520 may then generate appropriate audio/visual signals for the audio indicator 558 and visual indicator 554 to show appropriate range indication as discussed above. In some embodiments, the button module 564 may also include a learn button (not shown) enabling a user to include the sensing device 516 into an existing home network, such as, for example, the network 508. In other embodiments, the button module 564 may also include a tamper button (not shown) enabling a user to identify the sensing device 516 have been removed or moved to a different location.

In some embodiments, the sensing device 516 may also repeat signals from the home network manager 510 so as to enable the home network manager 510 to control network devices 504 or another sensing device 578 via the sensing device 516. It should be understood that the network device 504 as illustrated in FIG. 5 is not exhaustive. That is, the sensing device 516 may enable a user to control any network device 504 connected to the network 508. In other embodiments, the sensing device 516 may also communicate an alarm signal or indication when the control device 504 has been in a predefined state or condition, such as, for example, when the garage gate is opened at 1 am. In this regard, the sensing device 516 may communicate the alarm signal directly to an alarm, similar to the alarm 120i of FIG. 1, or indirectly through the network manager 510 to interface devices, similar to the interface devices 240 of FIG. 2. Thus, the sensing device 516 may perform as a bi-directional communication device.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for a door/window sensor.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A control system for use with a control device in a network, the control system comprising:
a sensing device configured to monitor a distance of said sensing device from said control device, and to communicate a first indication in response to said distance exceeding a predefined value through said network;
a binary device being coupled to said sensing device, and, in response to receiving a number of inputs, configured to generate a number of signals, and to communicate said number of signals through said network via said sensing device; and
a network manager, being remote from said binary device and said sensing device, configured to receive at least one of said first indication and said number of signals, and, in response to having received said at least one of said first indication and said number of signals, to activate one of a plurality of corresponding predefined actions.

2. A control system of claim 1, and wherein said network manager is further configured to determine if a predefined condition is met, and, in response to said predefined condition having been met, and said at least one of said first indication and said number of signals having been received, to activate at least one of said plurality of corresponding predefined actions.

3. A control system of claim 2, and wherein said predefined condition comprises at least one of a time of day, a day of a week, lighting conditions, humidity conditions, and a presence of a mobile device within a vicinity of the sensing device.

4. A control system of claim 1, and wherein said control device comprises at least one of a reed sensor device, a temperature sensor device, and a network device of said network.

5. A control system of claim 1, and wherein said predefined actions comprise activating a network device of said network, preventing a network device of said network from functioning, and communicating said at least one of said first indication and said number of signals to an interface device.

6. A control system of claim 1, and wherein said control device comprises at least one of a gate, a door, a window, a set of roller blinds, and a garage gate.

7. A control system of claim 1, further comprising a temperature sensor configured to measure temperature proximate said sensing device, and wherein said network manager is further configured to activate one of said plurality of corresponding predefined actions when said temperature exceeds a predefined temperature limit.

8. A control system for use with a control device in a network, the control system comprising:
a network device communicatively coupled to said network, and configured to perform a function;
a sensing device configured to monitor a distance of said sensing device from said control device, and to communicate a first indication in response to said distance exceeding a predefined value;
a network manager, being remote from said network device, and being communicatively coupled to said network device and to said sensing device, configured to receive said first indication, and in response to having received said first indication, to communicate a second indication to said sensing device; and
wherein said sensing device, in response to having received said second indication from said network manager, is further configured to communicate said second indication to said network device through said network, and
wherein said network device, in response to having received said second indication from said sensing device through said network, is further configured to perform said function.

9. A control system of claim 8, and wherein said network manager is further configured to determine if a predefined condition is met, and, in response to said predefined condition having been met and said first indication having been received, to activate at least one of a plurality of predefined actions.

10. A control system of claim 9, and wherein said predefined condition comprises at least one of a time of day, a day of a week, lighting conditions, humidity conditions, and a presence of a mobile device within a vicinity of the sensing device.

11. A control system of claim 8, and wherein said control device comprises at least one of a reed sensor device, a temperature sensor device, and a network device of said network.

12. A control system of claim 8, and wherein said function comprises activating said network device of said network, preventing said network device of said network from functioning, and communicating said first indication to an interface device.

13. A control system of claim 8, and wherein said control device comprises at least one of a gate, a door, a window, a set of roller blinds, and a garage gate.

14. A control system of claim 8, further comprising a temperature sensor configured to measure temperature proximate said sensing device, and wherein said network device is further configured to perform said function when said temperature exceeds a predefined temperature limit.

15. A method of controlling a network device operable to perform a function in a network via a) a sensing system for use with a control device, and being remote from said network device, and b) a network manager operable to communicate with said network device and said sensing system, the method comprising:
determining a distance of said sensing device from said control device;
in response to having detected said distance exceeding a predefined value, communicating a first indication from said sensing system to said network manager;
in response to having received said first indication at said network manager, communicating a second indication from said network manager to said sensing device;
in response to having received said second indication at said sensing device, communicating said second indication from said sensing device to said network device; and
performing said function at said network device in response to receiving said second indication at said network device.

16. A method of claim 15, and further comprising determining if a predefined condition is met, and, in response to said predefined condition having been met and said first indication having been received, activating from said network manager a predefined action.

17. A method of claim 16, and wherein said predefined condition comprises at least one of a time of day, a day of a week, lighting conditions, humidity conditions, and a presence of a mobile device within a vicinity of the sensing device.

18. A method of claim 15, and wherein said control device comprises at least one of a reed sensor device, a temperature sensor device, and a network device of said network.

19. A method of claim 15, and wherein said control device comprises at least one of a gate, a door, a window, a set of roller blinds, and a garage gate.

20. A method of claim 15, further comprising:
measuring temperature proximate said sensing device; and
performing said function at said network device when said temperature exceeds a predefined temperature limit.
